(19) United States
(12) Patent Application Publication
(10) Pub. No.: US 2026/0259689 A1
(43) Pub. Date: Sep. 3, 2026

(54) ELECTRONIC DEVICE AND DISPLAY METHOD

(71) Applicant: Lenovo (Beijing) Limited, Beijing (CN)

(72) Inventor: Binqiang MA, Beijing (CN)

(21) Appl. No.: 19/455,256

(22) Filed: Jan. 21, 2026

(30) Foreign Application Priority Data
Feb. 28, 2025 (CN) 202510237938.3

(51) Int. Cl. G06F 3/14; G06F 1/16

(52) U.S. Cl. CPC G06F 3/1431; G06F 1/1618; G06F 1/1677

(57) ABSTRACT

An electronic device includes first body including first and second surfaces opposite to each other, second body rotatably connected to the first body and including third and fourth surfaces opposite to each other, and display unit disposed at the first and third surfaces with them being first and second display areas of the display unit, respectively. When the electronic device is in first attitude, the first and third surfaces are coplanar, angle between the second and fourth surfaces is first angle, and the first and second display area output image to present first target visual effect. When the electronic device is in second attitude, the first and third surfaces are not coplanar, the angle between the second and fourth surfaces is second angle smaller than the first angle, the first and second display areas output the image to present second target visual effect different from the first target visual effect.

### CROSS-REFERENCE TO RELATED APPLICATION

This application claims priority to Chinese Patent Application No. 202510237938.3, filed on February 28, 2025, the entire content of which is incorporated herein by reference.

### TECHNICAL FIELD

The present disclosure generally relates to the field of electronic technologies and, more particularly, to an electronic device and a display method.

### BACKGROUND

With the development of information technology, new forms of electronic devices, such as flexible-screen computers, are becoming increasingly widely used. However, current new forms of electronic devices all use the same visual effect in different states, failing to highlight their uniqueness.

### SUMMARY

In accordance with the disclosure, there is provided an electronic device including a first body including a first surface and a second surface opposite to each other, a second body rotatably connected to the first body and including a third surface and a fourth surface opposite to each other, and a display unit disposed at the first surface and the third surface, the first surface being a first display area of the display unit and the third surface being a second display area of the display unit. The electronic device has a first attitude and a second attitude. When the electronic device is in the first attitude, the first surface and the third surface are coplanar, an angle between the second surface and the fourth surface is a first angle, the first display area outputs a first portion of an image, and the second display area outputs a second portion of the image, such that the image presents a first target visual effect. When the electronic device is in the second attitude, the first surface and the third surface are not coplanar, the angle between the second surface and the fourth surface is a second angle smaller than the first angle, the first display area outputs the first portion of the image, and the second display area outputs the second portion of the image, such that the image presents a second target visual effect different from the first target visual effect.

Also in accordance with the disclosure, there is provided a display method applied to an electronic device. The electronic device includes a first body with a first surface and a second surface opposite to each other, a second body rotatably connected to the first body with a third surface and a fourth surface opposite to each other, and a display unit disposed at the first surface and the third surface with the first surface being a first display area of the display unit and the third surface being a second display area of the display unit. The method includes in response to determining that the electronic device is in a first attitude where the first surface and the third surface are coplanar and an angle between the second surface and the fourth surface is a first angle, setting the first display area to output a first portion of an image, and the second display area to output a second portion of the image, such that the image presents a first target visual effect, and in response to determining that the electronic device is in a second attitude where the first surface and the third surface are not coplanar and the angle between the second surface and the fourth surface is a second angle smaller than the first angle, setting the first display area too output the first portion of the image, and the second display area to output the second portion of the image, such that the image presents a second target visual effect different from the first target visual effect.

Also in accordance with the disclosure, there is provided a non-transitory computer-readable storage medium storing a computer program that, when executed by a processor of an electronic device, cause the electronic device to perform a display method. The electronic device includes a first body with a first surface and a second surface opposite to each other, a second body rotatably connected to the first body with a third surface and a fourth surface opposite to each other, and a display unit disposed at the first surface and the third surface with the first surface being a first display area of the display unit and the third surface being a second display area of the display unit. The method includes in response to determining that the electronic device is in a first attitude where the first surface and the third surface are coplanar and an angle between the second surface and the fourth surface is a first angle, setting the first display area to output a first portion of an image, and the second display area to output a second portion of the image, such that the image presents a first target visual effect, and in response to determining that the electronic device is in a second attitude where the first surface and the third surface are not coplanar and the angle between the second surface and the fourth surface is a second angle smaller than the first angle, setting the first display area too output the first portion of the image, and the second display area to output the second portion of the image, such that the image presents a second target visual effect different from the first target visual effect.

### BRIEF DESCRIPTION OF THE DRAWINGS

FIG. 1A is a schematic diagram of an electronic device consistent with embodiments of the present disclosure.

FIG. 1B is a schematic diagram of an electronic device in a first attitude consistent with embodiments of the present disclosure.

FIG. 1C is a schematic diagram of an electronic device with a third angle smaller than 90 degrees consistent with embodiments of the present disclosure.

FIG. 2A is a schematic diagram of an electronic device displaying rivers and waterfalls consistent with embodiments of the present disclosure.

FIG. 2B is a schematic diagram of another electronic device consistent with embodiments of the present disclosure.

FIG. 2C is a schematic diagram showing a third angle and a second angle consistent with embodiments of the present disclosure.

FIG. 3A is a schematic diagram showing a displayed image of an electronic device consistent with embodiments of the present disclosure.

FIG. 3B is a schematic diagram showing another displayed image of an electronic device consistent with embodiments of the present disclosure.

FIG. 3C is a schematic diagram showing another displayed image of an electronic device consistent with embodiments of the present disclosure.

FIG. 4A is a schematic diagram showing angles of an A side, a B side, and a C side of an electronic device consistent with embodiments of the present disclosure.

FIG. 4B is another schematic diagram showing angles of an A side, a B side, and a C side of an electronic device consistent with embodiments of the present disclosure.

FIG. 4C is a schematic diagram of an electronic device in a tablet mode consistent with embodiments of the present disclosure.

FIG. 4D is a schematic diagram of an electronic device in a reading mode consistent with embodiments of the present disclosure.

FIG. 4E is a schematic diagram of an electronic device in a closed mode consistent with embodiments of the present disclosure.

FIG. 4F is a schematic diagram of an electronic device in a tent mode consistent with embodiments of the present disclosure.

FIG. 4G is a schematic diagram of an electronic device in a vertical mode consistent with embodiments of the present disclosure.

FIG. 5 is a schematic structural diagram of a display apparatus consistent with embodiments of the present disclosure.

FIG. 6 is a schematic hardware diagram of an electronic device consistent with embodiments of the present disclosure.

### DETAILED DESCRIPTION OF THE EMBODIMENTS

Various schemes and features of the present disclosure are described herein with reference to the accompanying drawings. The embodiments in the present disclosure are only used to describe the present disclosure and are not intended to limit the scope of the present disclosure. It is understandable that other embodiments obtained by those skilled in the art without inventive effort are within the scope of the present disclosure.

In the following description, references to “some embodiments” describe a subset of all possible embodiments. However, it is understood that “some embodiments” may be the same or different subsets of all possible embodiments and may be combined with each other without conflict.

The terms “first/second/third” are used merely to distinguish similar objects and do not represent a specific ordering of objects. It is understood that “first/second/third” may be interchanged in a specific order or sequence where permitted, such that the embodiments of the present disclosure described herein can be implemented in orders other than those illustrated or described herein.

Unless otherwise defined, all technical and scientific terms used in the present disclosure have the same meaning as those generally understood by those skilled in the art. The terms used in the present disclosure are only for the purpose of description and are not intended to limit the scope of the present disclosure.

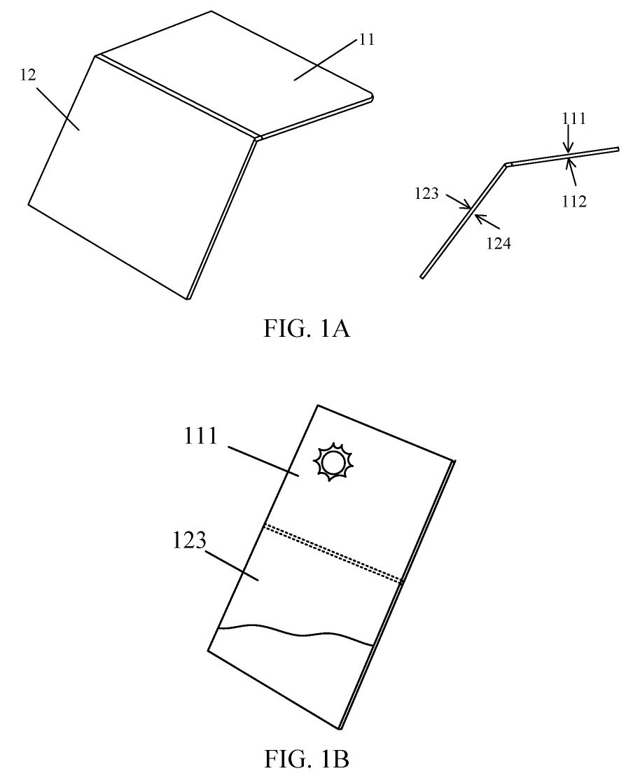

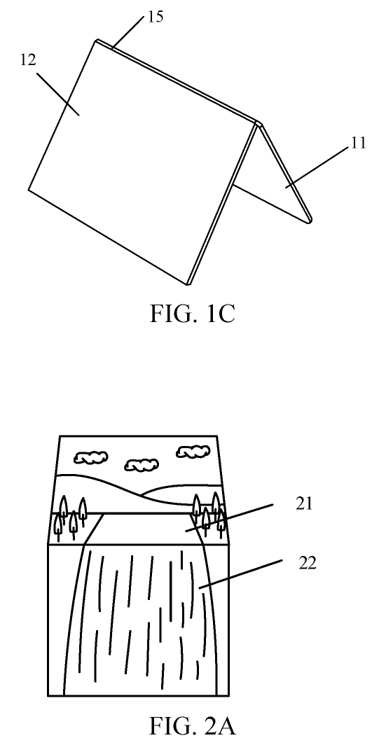

The present disclosure provides an electronic device. In one embodiment, as shown in FIG. 1A, the electronic device includes a first body 11, a second body 12, and a display unit 13.

The first body 11 may have a first surface 111 and a second surface 112, which are opposite to each other.

A first display area of the display unit may be disposed at the first surface 111, and the second surface 112 may be a back surface of the display unit, i.e., a surface that is able to be disposed at a rear shell of the first body. The display unit may be a flexible screen, and the first display area may be a portion of the display area of the flexible screen.

The second body 12 may be rotatably connected to the first body and may have a third surface 123 and a fourth surface 124, which are opposite to each other.

A second display area of the display unit may be disposed at the third surface 123, and the fourth surface 124 may be the back surface of the display unit, i.e., a surface that is able to be disposed at a rear shell of the second body. The display unit may be a flexible screen, and the second display area may be another portion of the display area of the flexible screen.

The display unit 13 may be disposed at the first surface 111 and the third surface 123. The first surface 111 may be the first display area 131 of the display unit 13, and the third surface 123 may be the second display area 132 of the display unit 13.

As shown in FIG. 1B, when the electronic device is in a first attitude, the first surface 111 and the third surface 123 are coplanar, and the angle between the second surface and the fourth surface is a first angle. The first display area may output a first portion of an image, and the second display area may output a second portion of the image, such that the image presents a first target visual effect.

The first surface 111 and the third surface 123 may be coplanar, meaning the flexible screen is physically aligned on a single plane. Since the second surface and the fourth surface are the back surfaces corresponding to the first surface and the third surface respectively, and the first angle is 180 degrees, the first surface and the third surface may be kept on a single plane. The first display area of the flexible screen may display the first portion of the image, and the second display area may display the second portion of the image. The first target visual effect presented on the flexible screen may be a single two-dimensional image or a single three-dimensional image.

As shown in FIG. 1A, when the electronic device is in a second attitude, the first surface 111 and the third surface 123 are not coplanar, and the angle between the second surface 112 and the fourth surface 124 is a second angle, which is smaller than the first angle. The first display area may output the first portion of the image, and the second display area may output the second portion of the image, such that the image presents a second target visual effect. The second target visual effect may be different from the first target visual effect.

The first surface 111 and the third surface 123 may not be coplanar, meaning that the flexible screen physically corresponds to two planes with an angle. Since the second surface and the fourth surface are the back surfaces corresponding to the first surface and the third surface respectively, and the second angle is smaller than the first angle (less than 180 degrees), when the flexible screen is bent, although the first display area still outputs the first portion of the image and the second display area outputs the second portion of the image, the display unit may present the second target visual effect different from the first target visual effect. The second target visual effect may be generated by the bending of the flexible screen.

In some embodiments, when the electronic device is in the first attitude, the first surface and the third surface may satisfy the coplanarity condition (i.e., being coplanar), such that the image output from the first surface and the third surface may present the first target visual effect. When the electronic device is in the second attitude, the first surface and the third surface may not satisfy the coplanarity condition, such that the image output from the first surface and the third surface may present the second target visual effect different from the first target visual effect. Therefore, the electronic device may be able to present different visual effects as the attitude changes (the flexible screen changes) when it is in different attitudes, reflecting the uniqueness of the content displayed by the flexible screen electronic device.

In some embodiments, the image may be a two-dimensional image.

When the electronic device is in the first attitude, the two-dimensional image output by the display unit may have a planar visual effect.

The planar visual effect may refer to an image that appears flat, lacking depth or three-dimensionality. In practice, when the flexible screen on the electronic device is on a plane, the displayed two-dimensional image may have a planar visual effect.

When the electronic device is in the second attitude, the two-dimensional image output by the display unit may have a stereoscopic visual effect.

The stereoscopic visual effect may refer to the ability to distinguish the distance and shape of objects when observing a scene with two eyes. The stereoscopic visual effect may allow users to perceive the three-dimensional structure of objects displayed in the image, including the position, distance, depth, or three-dimensional spatial characteristics such as convexity and concavity. In practice, when the flexible screen on the electronic device is on two planes with an angle between them, various methods such as lighting effects, depth of field enhancement, perspective principles, angle changes and animation effects, or image processing techniques may be used to make the two-dimensional image appear three-dimensional.

In some embodiments, in the first attitude, the electronic device may output a planar visual image; and, in the second attitude, the display unit may output a stereoscopic visual image. Therefore, when the electronic device is in different attitudes, the two-dimensional image may present a planar visual effect or a stereoscopic visual effect as the attitude changes (the flexible screen changes).

In some embodiments, the electronic device may have a first usage state and a second usage state.

When the electronic device is in the first usage state, the angle between the second surface and the fourth surface may be the first angle.

In the first usage state, the angle between the second surface and the fourth surface may be the first angle, such that the first surface and the third surface remain on the same plane. The first usage state may correspond to the state shown in FIG. 1B, where the display unit 13 may serve as a flat screen for the user to use.

When the electronic device is in the second usage state, the angle between the second surface and the fourth surface may be a third angle, where the third angle is smaller than the second angle.

When the third angle is smaller than the second angle, the electronic device may not be in the second attitude. For example, when the second angle is 90 degrees and the third angle is less than 90 degrees, the user may see the second surface, but the first surface may be very likely invisible. Therefore, the second usage state may be a state where the first surface is not in use, and the first surface may be set to a screen-off state.

For example, when the second angle is less than 180 degrees but greater than 90 degrees, the first surface may be set to a working state. As shown in FIG. 1C, when the third angle is less than 90 degrees, the first surface may be set to a screen-off state.

During the process of the electronic device switching from the first usage state to the second usage state, fluid-related display parameters in the image may be adjusted such that the changing trend of the angle between the fluid flow path in the first display area and the fluid flow path in the second display area satisfies is opposite to the changing trend of the angle between the first body and the second body.

For example, when the electronic device switches from the first usage state to the second usage state, the angle between the second surface and the fourth surface of the electronic device may change from 180 degrees to 90 degrees; that is, the flexible screen may switch from one plane to two planes with a 90-degree angle.

Fluid in the image may be flowing objects in the image, such as rivers or waterfalls. Fluid-related display parameters may include parameters that are able to adjust the angle between the fluid and other fixed objects in the image, the fluid’s flow speed, the fluid’s flow path, or the mass of the fluid per unit volume.

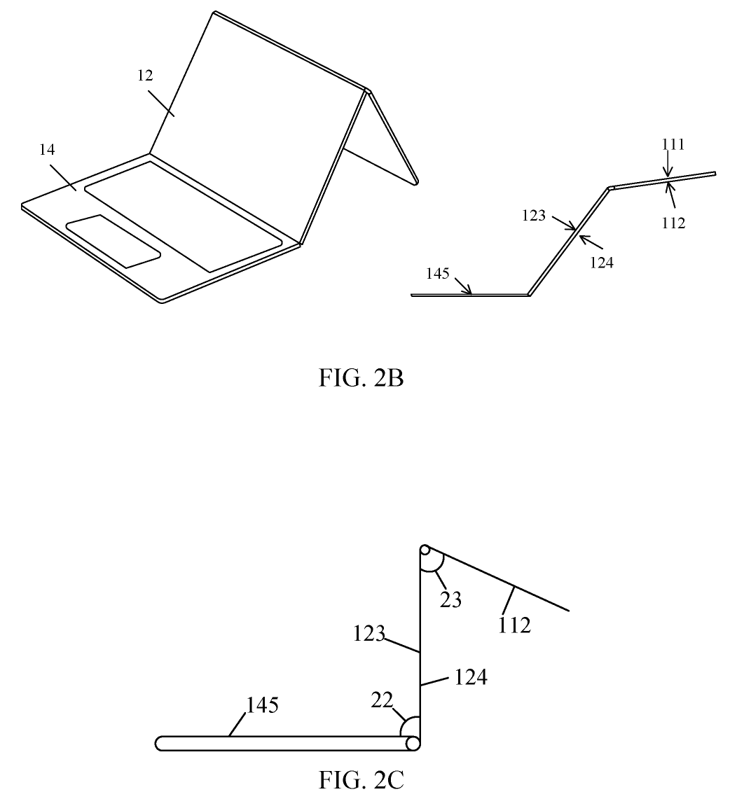

During implementation, by adjusting the fluid-related display parameters in the image, the changing trend of the angle between the flow path of the fluid in the first display area and the flow path of the fluid in the second display area may be made opposite to the changing trend of the angle between the first body and the second body. For example, as the angle between the second surface and the fourth surface changes from 180 degrees to 90 degrees (the angle gradually decreases), as shown in FIG. 2A, the angle between the flow path of a river in the first display area and the flow path of a waterfall in the second display area may be gradually increased by adjusting the display parameters related to the river 21 or the waterfall 22 in the image, that is, the display effect may be adjusted from a planar visual effect to a stereoscopic visual effect.

In some embodiments, during the switching of the electronic device from the second usage state to the first usage state, the fluid-related display parameters in the image may be adjusted such that the changing trend of the angle between the fluid flow path in the first display area and the fluid flow path in the second display area is opposite to the changing trend of the angle between the first body and the second body.

For example, as the angle between the second surface and the fourth surface changes from 90 degrees to 180 degrees (the angle gradually increases), the display parameters related to the river or waterfall in the image may be adjusted such that the angle between the river flow path in the first display area and the waterfall flow path in the second display area gradually decreases, thus adjusting the display effect from a stereoscopic visual effect to a planar visual effect.

In some embodiments, during the switching of the electronic device from the first usage state to the second usage state, adjusting the fluid-related display parameters in the image may make the changing trend of the angle between the fluid flow path in the first display area and the fluid flow path in the second display area satisfy the “being opposite” condition with the changing trend of the angle between the first body and the second body, which may allow the viewer to see a dynamically changing fluid flow paths, resulting in a stereoscopic visual effect.

In some embodiments, when the third angle is within a first preset angle range, the electronic device may be in the second usage state.

The first preset angle range may be set by the user according to actual usage needs, or may be determined based on the user’s line of sight, or may be determined based on usage experience. For example, when it is determined that the user cannot see the first surface, the third angle may be determined to meet the first preset angle range. In some embodiments, the first preset angle range may be set to 90 degrees to 0 degrees, and the electronic device may be determined to be in the second state when the third angle is between 0 degrees and 90 degrees.

The electronic device may further include a third body connected to the second body, and may have a fifth surface that is able to face the third surface. When the third angle is less than or equal to the angle between the third surface and the fifth surface, the electronic device may be in the second usage state.

As shown in FIG. 2B, in one embodiment, the electronic device further includes a third body 14 connected to the second body 12, which has a fifth surface 145 that is able to face the third surface 123.

As shown in FIG. 2C, when the third angle 23 (the angle between the second surface 112 and the fourth surface 124) is less than or equal to the angle 22 between the third surface 123 and the fifth surface 124, the electronic device may be in the second usage state. For example, when the angle 22 is 90 degrees, and the third angle 23 is less than or equal to 90 degrees, the electronic device may be in the second usage state.

In some embodiments, based on a predetermined first preset angle orientation, it may be determined that when the third angle is within the first preset angle range, the electronic device is in the second usage state, meaning that the third surface of the electronic device cannot be seen by the user.

The electronic device may include the third body connected to the second body and may have the fifth surface that is able to be opposite to the third surface. When the third angle is less than or equal to the angle between the third surface and the fifth surface, it may be determined that the electronic device is in the second usage state, meaning that the third surface of the electronic device cannot be seen by the user.

In some embodiments, during the process of the electronic device switching from the first attitude to the second attitude, the display information of the first portion of the image output by the first display area and the display information of the second portion of the image output by the second display area may be adjusted such that the images present different display effects.

The electronic device may switch from the first attitude to the second attitude, which is the process of the flexible screen of the electronic device switching from one plane to two planes with an angle between them. The image display information may include the image’s position information, color information, brightness information, or angles between objects in the image.

Adjusting the display information of the first portion of the image output from the first display area and the second portion of the image output from the second display area may be based on adjusting the color information of certain objects in the first display area and the color information of certain objects in the second display area according to the change in the angle between the second surface and the fourth surface. In some embodiments, the adjusting may involve gradually adjusting target objects in the first display area to be displayed in the second display area, i.e., adjusting the position information. Different display effects on the images displayed on the flexible screen during the transition from the first attitude to the second attitude may be achieved.

In some embodiments, the display information of the first portion of the image output from the first display area and the second portion of the image output from the second display area may also be adjusted during the transition from the second attitude to the first attitude to achieve different display effects.

In some embodiments, during the switching of the electronic device from the first attitude to the second attitude, different display effects may be achieved by adjusting the display information of the first portion of the image output from the first display area and the display information of the second portion of the image output from the second display area.

In some embodiments, the display information may include a display position of a target image element.

During the switching of the electronic device from the first attitude to the second attitude, the relative position change information between the first body and the second body may be obtained.

For example, during the switching of the electronic device from the first attitude to the second attitude, the relative position change information between the first body and the second body may be determined based on the angle between the second surface and the fourth surface. In one embodiment, an angle sensor disposed at the connection between the first body and the second body may be used to obtain the change in the angle and determine the relative position change information between the first body and the second body. In some embodiments, in some other embodiments, at least one of sensors including an accelerometer, a gyroscope, or a gravity sensor, disposed at the second body or the first body, may be used to obtain the relative position change information between the first body and the second body.

Based on the relative position change information, the display position of the target image element may be adjusted.

The target image element may be a target object in the image. For example, the target image element may be a target object whose position changes in the image, such as a rising sun.

In one embodiment, the display position of the target image element may be adjusted based on the relative position change information. For example, the display position of the sun in the image may be adjusted based on the angle between the second surface and the fourth surface, such that the sun moves from the second display area to the first display area.

In some embodiments, during the process of the electronic device switching from the second attitude to the first attitude, the relative position change information of the first body and the second body may be obtained, and the display position of the target image element may be adjusted according to the relative position change information.

When the electronic device switches from the second attitude to the first attitude, i.e., when the flexible screen switches from a bent state to a flattened state, the relative position change information of the first body and the second body may be determined based on the angle between the two surfaces of the flexible screen in the bent state, and then the display position of the target image element may be adjusted according to the relative position change information. For example, the display position of the sun in the image may be adjusted based on the angle between the second surface and the fourth surface, such that the sun moves from the first display area to the second display area.

In some embodiments, the display information may include the display position of the target image element, and the relative position change information of the first body and the second body may be obtained during the process of the electronic device switching from the first attitude to the second attitude. Therefore, the display position of the target image element may be adjusted based on the relative position change information, realizing the linkage between the movement of the target image element and the relative position change information. That is, when the angle between the first body and the second body is adjusted, the user may see the target image element that changes with the angle.

In some embodiments, the display unit may further include a third display area, which is connected to the first display area and the second display area, and the third display area may have different display orientations.

As shown in FIG. 1C, in one embodiment, the third display area 15 is connected to the first display area disposed at the first body 11 and the second display area disposed at the second body 13.

The adjustment of the display information of the first portion of the image output from the first display area and the display information of the second portion of the image output from the second display area during the process of the electronic device switching from the first attitude to the second attitude may include:

in response to the electronic device switching from the first attitude to the second attitude, adjusting the display position of the target image element in the image from a position away from the third display area to a position closer to the third display area; or

in response to the electronic device switching from the second attitude to the first attitude, adjusting the display position of the target image element in the image from a position closer to the third display area to a position away from the third display area.

For example, during the process of the flexible screen of the electronic device switching from an unfolded state to a folded state, i.e., the angle between the second surface and the fourth surface changing from 180 degrees to 90 degrees, the position of, for example, the sun in the image, may be adjusted from a position away from the third display area to a position closer to the third display area in the second display area, such that the sun is able to be seen moving from bottom to top into the third display area.

For example, when the flexible screen of an electronic device changes from the folded state to the unfolded state, that is, when the angle between the second surface and the fourth surface changes from 90 degrees to 180 degrees, the position of, for example, the sun in the image, may be adjusted from a position closer to the third display area to a position farther away from the third display area in the second display area, such that the reflection of the sun is able to be seen moving from top to bottom.

In some embodiments, the display unit may further include the third display area, which may be connected to the first display area and the second display area and may have different display orientations. The electronic device may switch between the first attitude and the second attitude, thereby adjusting the display position of the target image element in the image relative to the third display area in different directions, enabling the target image element to move in the corresponding direction as the attitude changes.

In some embodiments, the display unit may further include a third display area connected to the first display area and the second display area, and the third display area may have different display orientations.

Adjusting the display information of the first portion of the image output by the first display area and the display information of the second portion of the image output by the second display area during the process of the electronic device switching from the first attitude to the second attitude may include:

in response to the electronic device switching from the first attitude to the second attitude, adjusting the display position of the target image element in the image from the first display area, through the third display area, to the second display area, where the movement distance of the target image element in the first display area and the movement distance of the target image element in the second display area satisfy the “being same” condition; or

in response to the electronic device switching from the second attitude to the first attitude, adjusting the display position of the target image element in the image from the second display area, through the third display area, to the first display area, where the movement distance of the target image element in the first display area and the movement distance of the target image element in the second display area satisfy the “being same” condition.

For example, during the process of the flexible screen of the electronic device switching from an unfolded to a folded state, i.e., when the angle between the second and fourth surfaces changing from 180 degrees to 90 degrees, adjusting, for example, the sun in the image, from the first display area, through the third display area, to the second display area, which allow the sun to be seen moving from top to bottom from the first display area through the third display area to the second display area, demonstrating the process of the sun gradually setting. During this process, the movement distance of the sun in the first display area may be the same as the movement distance of the sun in the second display area.

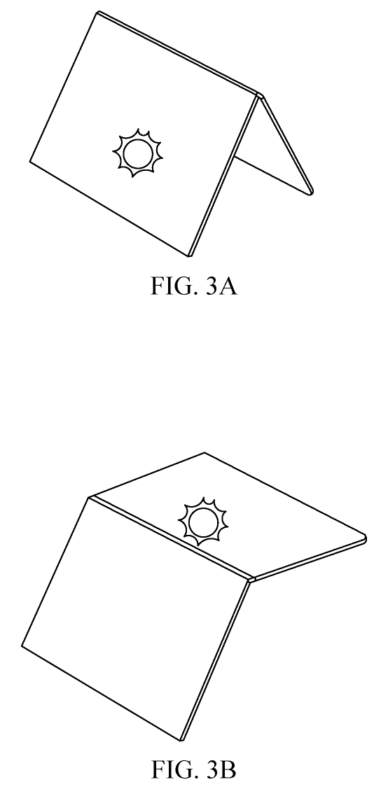

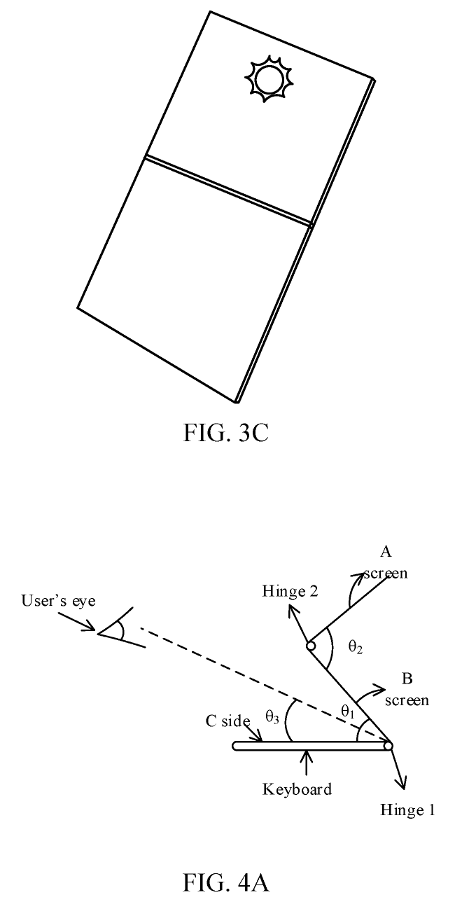

For example, during the process of the flexible screen of the electronic device changing from a folded state to an unfolded state (i.e., when the angle between the second surface and the fourth surface changes from 90 degrees to 180 degrees), as shown in FIGS. 3A, 3B and 3C, adjusting, for example, the sun in the image, from the second display area, through the third display area, to the first display area, which allows the sun to be seen moving upwards from the second display area through the third display area to the first display area, demonstrating the gradual rising of the sun. During this process, the movement distance of the sun in the first display area and the movement distance of the sun in the second display area may be the same.

In some embodiments, when the electronic device switches from the first attitude to the second attitude, the display position of a target image element in the image may be adjusted to move from the first display area, through the third display area, to the second display area; and, conversely, when the electronic device switches from the second attitude to the first attitude, the display position of the target image element in the image may be adjusted to move from the second display area, through the third display area, to the first display area. The movement distance of the target image element in the first display area and the movement distance of the target image element in the second display area may satisfy the “being same” condition. This may allow the target image element to move in different directions through the third display area with each switch between the first attitude and the second attitude. Also, since the movement distance of the target image element in the first display area and the movement distance of the target image element in the second display area satisfy the “being same” condition, a visual effect of the target image element moving at a uniform speed with the change in attitude may be provided.

In some embodiments, the display unit further may include a third display area connected to the first display area and the second display area, and the third display area may have different display orientations. The target image element may include a first sub-element that may be displayed in the first display area and a second sub-element that may be displayed in the second display area, and the first sub-element and the second sub-element may satisfy a symmetry condition relative to the third display area.

For example, the first sub-element may be the sun, and the second sub-element may be the sun’s reflection in water. The sun and the sun’s reflection may satisfy a symmetrical presentation condition relative to the third area.

The adjustment of the display information of the first portion of the image output by the first display area and the display information of the second portion of the image output by the second display area during the process of the electronic device switching from the first attitude to the second attitude may include:

in response to the electronic device switching from the first attitude to the second attitude, adjusting the display positions of the first sub-element and the second sub-element to move from a position away from the third display area to a position closer to the third display area, where the movement distance of the first sub-element and the movement distance of the second sub-element satisfy a matching relationship; or

in response to the electronic device switching from the second attitude to the first attitude, adjusting the display positions of the first sub-element and the second sub-element to move from a position closer to the third display area to a position farther away from the third display area, where the movement distance of the first sub-element and the movement distance of the second sub-element satisfy a matching relationship.

For example, during the process of the flexible screen of the electronic device switching from an unfolded to a folded state, i.e., when the angle between the second surface and the fourth surface changes from 180 degrees to 90 degrees, adjusting, for example, the sun and its reflection in the image, to move from a position away from the third display area to a position closer to the third display area, such that the sun’s reflection may be seen gradually approaching the third display area from bottom to top, showing the process of the sun’s reflection gradually rising, while simultaneously showing the process of the sun gradually setting from top to bottom. During this process, the movement distance of the sun in the first display area and the movement distance of the sun’s reflection in the second display area may satisfy the matching relationship, where the matching relationship ensures that the moving speeds of the sun and its reflection are consistent.

For example, during the process of the flexible screen of the electronic device changing from a folded state to an unfolded state, i.e., when the angle between the second surface and the fourth surface changes from 90 degrees to 180 degrees, the positions of, for example, the sun and its reflection in the image, may be adjusted from a position closer to the third display area to a position farther away from the third display area, which allows the sun’s reflection to be seen gradually moving away from the third display area from top to bottom, demonstrating the process of the sun’s reflection gradually descending, while simultaneously showing the sun gradually rising from bottom to top. During this process, the movement distance of the sun in the first display area and the movement distance of the sun’s reflection in the second display area may satisfy the matching relationship, where this matching relationship may ensure that the moving speeds of the sun and its reflection are consistent.

In some embodiments, the target image element may include the first sub-element that may be displayed in the first display area and the second sub-element that may be displayed in the second display area, and the first sub-element and the second sub-element may satisfy a symmetry condition relative to the third display area. When the electronic device switches from the first attitude to the second attitude, the display positions of the first sub-element and the second sub-element may be adjusted to move from a position away from the third display area to a position closer to the third display area. Conversely, when the electronic device switches from the second attitude to the first attitude, the display positions of the first sub-element and the second sub-element may be adjusted to move from a position closer to the third display area to a position away from the third display area. The movement distances of the first sub-element and the second sub-element may satisfy a matching condition. This may allow for symmetrical movement of two mutually symmetrical elements during the switching process between the first attitude and the second attitude.

The present disclosure also provides a display method applied to an electronic device. The electronic device may include: a first body including a first surface and a second surface opposite to each other; a second body rotatably connected to the first body and including a third surface and a fourth surface opposite to each other; and a display unit disposed at the first surface and the third surface. The first surface may be a first display area of the display unit, and the third surface may be a second display area of the display unit, as shown in FIG. 3. The display method may include:

S310: when determining that the electronic device is in a first attitude, where the first surface and the third surface are coplanar and the angle between the second surface and the fourth surface is a first angle, setting the first display area to output a first portion of an image, and the second display area to output a second portion of the image, such that the image presents a first target visual effect; and

S320: when determining that the electronic device is in a second attitude, where the first surface and the third surface are not coplanar and the angle between the second surface and the fourth surface is a second angle smaller than the first angle, setting the first display area to output the first portion of the image, and the second display area to output the second portion of the image, such that the image presents a second target visual effect, where the first target visual effect is different from the second target visual effect.

In some embodiments, when the first surface and the third surface of the electronic device satisfy the coplanarity condition in the first attitude, the images output from the first surface and the third surface may be configured to present the first target visual effect. When the first surface and the third surface of the electronic device do not satisfy the coplanarity condition in the second attitude, the images output from the first surface and the third surface may be configured to present the second target visual effect different from the first target visual effect. This may allow the electronic device to present different visual effects depending on its attitude (change in the flexible screen), highlighting the uniqueness of the content displayed on the flexible screen electronic device.

The present disclosure provides a foldable laptop computer whose screen is able to be flipped 180 degrees backward. Dynamic wallpapers/transition animations may be designed for the process of switching between the two forms - the screen in a flat plane and the screen flipped 180 degrees. These animations may change as the user bends the screen.

The first part of the computer may be a keyboard area, referred to as the C-side (the third body). The lower half of the screen may be referred to as the B screen (the second body), and the upper half that is able to be bent to the back may be referred to as the A screen (the first body). The A screen and the B screen may be a foldable flexible screen, and not two separate screens joined together.

In one embodiment, an angle sensor may be disposed at a hinge between the C-side and the B screen. When the angle changes, an event may be triggered to inform the upper-layer application (App) of the latest angle. An angle sensor may also be disposed at the hinge between the A screen and the B screen, triggering an event to inform the upper-layer application of the latest angle when the angle changes. The upper-layer application may be used to implement dynamic wallpapers/transition animations. These two angle values may be used to control the switching speed of the content displayed on the screen, thereby achieving an optimal user experience.

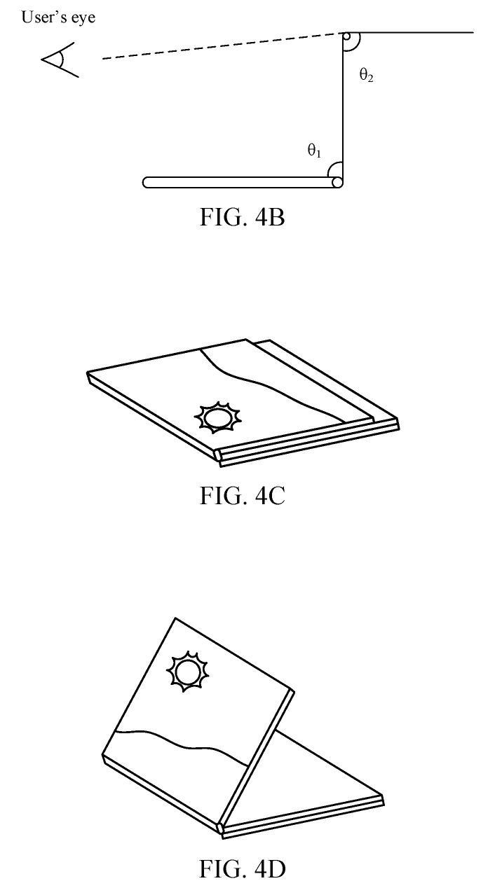

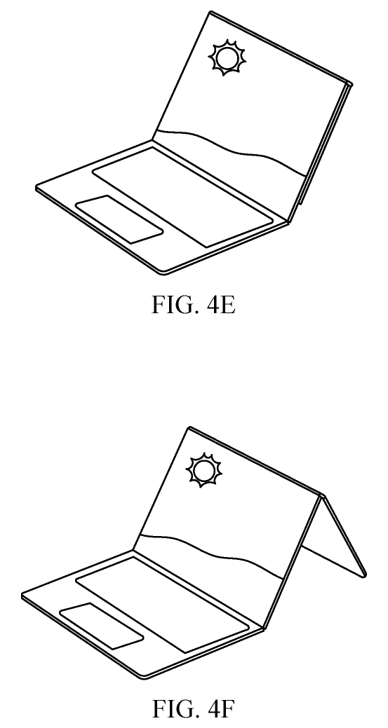

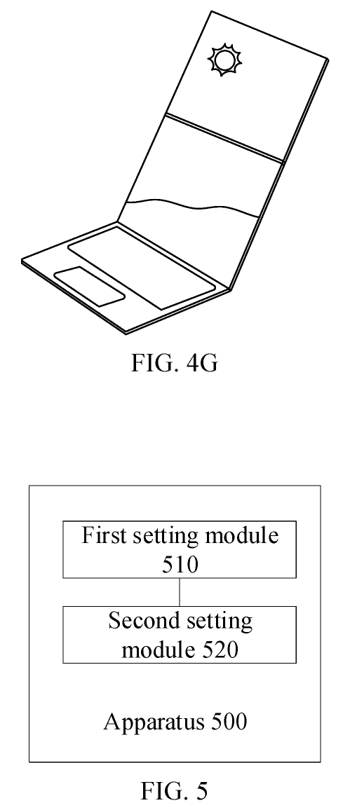

As shown in FIG. 4A, the angle between the keyboard C-side and the B screen is defined as θ1, and the angle between the A screen and the B screen is defined as θ2. The angle between the user’s line of sight and the keyboard C-side is defined as θ3.

When θ1 is less than θ3, the user’s line of sight may be parallel to the B screen, and the user may not be able to see the content on the B screen.

In one embodiment, based on empirical values, θ3 may be defined as a fixed value of 45°. Therefore, when θ1 is less than 45 degrees, the App may consider that the user cannot see the content on the B screen, and thus any animation effects on the B screen may be meaningless in this case. The App may switch the computer to a state where no transition animations play.

When θ1 is larger than 45 degrees, the App may be able to play transition animations.

When θ1 is a standard 90 degrees, the line of sight between the B screen and the A screen may be essentially parallel to the keyboard C side. As shown in FIG. 4B, when θ2 equals θ1, the A screen may be essentially parallel to the line of sight, and the user may not be able to see the A screen. When θ2 is less than θ1, the A screen may be hidden behind the B screen and the A screen may even be less visible. Therefore, playing animations on the A screen may be meaningless in this situation. Playing animations on the B screen may be meaningful. Therefore, when θ2 is less than θ1, the A screen may be set to a screen-off state.

In one embodiment, the App’s control logic may include:
1) First, when θ1 is greater than 45 degrees, the system enters a state where animations are able to be played;
2) When θ2 is less than θ1, the animations are played on the B screen, and when θ2 is greater than or equal to θ1, the animations are played on both the A screen and the B screen.

In some embodiments, when θ2 is greater than or equal to θ1, the main viewpoint of the animations may shift to the A screen.

For example, θ2 may initially start at 0 degrees (fully folded, referred to as the normal laptop mode). The animation may include a rising sun. The sun may initially appear in the center of the B screen. As the user begins to unfold the screen (when θ2 increases from 0 degrees), the animation may begin to make the sun rise. At this time, the distance between the sun and the third display area (the junction of the B screen and the A screen) may be x, and the difference between θ2 and the 90-degree angle at which the user is able to see the A screen may be degrees. x may be divided into 90-degree increments, and, for every 1-degree unfolding, the sun’s movement distance may be increased by x/90.

Thus, when θ2 reaches 90 degrees, the sun may just rise to the junction. When θ2 continues to unfold, the sun may continue to rise. The ascent may end when θ2 reaches 180 degrees.

The sun's ascent distance on the A screen may be the same as that on the B screen, ensuring the same ascent speed on the B screen. When the ascent distance on the A screen differs from that on the B screen, assuming the distance on the A screen is y, one may initially calculate the distance the sun moves for every 1 degree rotation on the A screen. Then, the distance the sun moves on the B screen may be proportionally increased or decreased, gradually approximating the distance moved per degree on the A screen. Therefore, when the screen unfolds at a constant speed, the sun may move at different speeds on the two screens.

In some embodiments, if θ1 is not 90 degrees, the trigger value of θ2 may also change. For example, if θ1 is 120 degrees, then θ2 may need to reach 120 degrees for the user to see the A screen. Thus, when θ2 is between 0 and 120 degrees, the sun may move on the B screen. When θ2 is between 120 and 60 degrees, the sun may move on the A screen. In this case, the method described above may be used to pre-calculate the distance the sun moves per degree on both screens.

In some embodiments, since the user actively moves their gaze to track and find the sun on the screen, a value of the angle θ2 (e.g., 90 degrees) may be used as a reference to determine whether to display the sun on the A screen. That is, if θ2 is greater than or equal to 90 degrees, the rising sun may begin to be displayed on the A screen. If θ2 is less than 90 degrees, the A screen may remain off.

In some embodiments, the starting point of the sun’s rising motion may not necessarily be θ2 equal to 0 degrees, and instead may be any angle where θ2 is less than θ1 (or a fixed angle such as 90 degrees), for example, 30 degrees. The ending motion may not necessarily be 180 degrees, and may be any angle where θ2 is greater than θ1 (or a fixed angle such as 90 degrees) but less than 180 degrees.

The movable element in the animation is not necessarily the sun, and may be a rocket, water ripples, or any other designed element.

The animated element may move only on the B screen, or move between the A screen. The purpose of including movable elements in the animation may be to trigger the user’s visual focus to follow the movable element from the B screen to the A screen.

When a foldable phone or tablet is used with a keyboard, this method may also be used to provide a smooth transition animation experience. In this case, there may be no hinge between the keyboard and the screen, and the relative angle between them may be obtained through sensors such as a gravity sensor (a G sensor).

In some embodiments, the flexible screen may be designed to display dynamically changing live wallpapers/transition animations during the switching between two forms (one plane and two planes forming an angle), presenting users with more varied visual effects.

In some embodiments, an angle sensor may be disposed at the hinge between the C-side and the B screen of the computer. An angle sensor may also be disposed at the hinge between the B screen and the A screen in the folding area of the screen. These angle sensors may be connected to an Electronic Control Unit (EC). When two angles are obtained using the angle sensors, and the EC determines that the two angles reach a corresponding angle combination, the EC may trigger a Windows Management Instrumentation (WMI) interrupt event. The EC may be a microcontroller, typically embedded in portable devices such as laptops or tablets, and may be used to monitor the hardware status of the device and communicate with the operating system to report these statuses or perform corresponding operations. Windows Management Interface (WMI) is a framework provided by the Windows operating system for managing data and operations, which allows user scripts or applications to access and manipulate Windows management information, such as device status and system settings.

After receiving the event, the upper-layer app may adjust the screen’s display area, orientation, or other settings according to preset patterns, thereby switching the device’s operating mode.

FIG. 4C, FIG. 4D, FIG. 4E, FIG. 4F, and FIG. 4G illustrate five operating modes of the electronic device provided in the embodiments of the present disclosure.

When θ1 is 0 degrees and θ2 is 0 degrees, the electronic device operates in a tablet mode as shown in FIG. 4C.

When θ1 is 0 degrees and θ2 is greater than 0 degrees, the electronic device operates in a reading mode as shown in FIG. 4D.

When θ1 is greater than 0 degrees and θ2 is 0 degrees, the electronic device operates in a closed mode as shown in FIG. 4E.

When θ1 is greater than 0 degrees and θ2 is greater than 0 degrees but less than 180 degrees, the electronic device operates in a tent mode as shown in FIG. 4F.

When θ1 is greater than 0 degrees and θ2 is equal to 180 degrees, the electronic device operates in a vertical mode as shown in FIG. 4G.

In the above embodiments, the angle definitions are for illustrative purposes only and may be adjusted according to actual conditions. For example, 0 degrees in the table mode may be between 0 and 10 degrees (to add redundancy and avoid frequent switching during use). For example, θ2 in the vertical mode may be between 90 and 180 degrees. This may allow for early switching to the desired mode during the transition between the two modes, improving the user experience.

The present disclosure also provides a display apparatus. Various modules included in the electronic device may be implemented using a processor in an electronic device or may be implemented using specific logic circuits. The processor may be a Central Processing Unit (CPU), a Microprocessor Unit (MPU), a Digital Signal Processor (DSP), or a Field Programmable Gate Array (FPGA), etc.

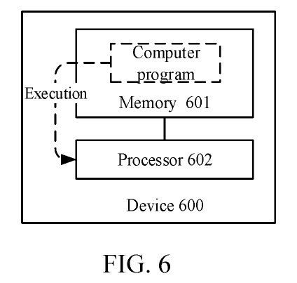

In one embodiment shown in FIG. 5, which is a schematic diagram of a display apparatus provided by the present disclosure, the display apparatus 500 includes:

a first setting module 510, configured to set the first display area to output a first portion of the image, and the second display area to output a second portion of the image, so that the image presents a first target visual effect, when determining that the electronic device is in a first attitude, where the first surface and the third surface satisfy the coplanar condition, and the angle between the second surface and the fourth surface is a first angle; and

a second setting module 520, configured to set the first display area to output a first portion of the image, and the second display area to output a second portion of the image, so that the image presents a second target visual effect different from the first target visual effect, when determining that the electronic device is in a second attitude where the first surface and the third surface do not satisfy the coplanar condition, and the angle between the second surface and the fourth surface is a second angle smaller than the first angle.

The descriptions of the above device embodiments are similar to those of the above method embodiments, and have similar beneficial effects. For technical details not disclosed in the device embodiments of this disclosure, references may be made to the descriptions of the method embodiments of this disclosure for understanding.

It should be noted that, in various embodiments of the present disclosure, when the above method is implemented in the form of software functional modules and sold or used as an independent product, it may also be stored in a computer-readable storage medium. Based on this understanding, the technical solution of the embodiments of this disclosure, in essence, or the part that contributes to the related technology, may be embodied in the form of a software product. This software product may be stored in a storage medium and includes several instructions to cause a computer device (which may be a personal computer, server, or network device, etc.) to execute all or part of the method provided by the various embodiments of this disclosure. The aforementioned storage medium may include various media capable of storing program code, such as USB flash drives, mobile hard drives, read-only memory (ROM), magnetic disks, or optical disks. Thus, the embodiments of this disclosure are not limited to any specific hardware, software, or firmware, or any combination of hardware, software, and firmware.

The present disclosure also provides a storage medium storing a computer program. When the computer program is executed by a processor, some or all of the processes in the display methods described above can be implemented.

The present disclosure also provides an electronic device. As shown in FIG. 6, which is a schematic hardware diagram of an electronic device provided by the present disclosure, in one embodiment, the electronic device 600 includes: a memory 601 and a processor 602. The memory 601 may be configured to store a computer program that is able to be executed on the processor 602. When the processor 602 executes the program, processes in the display methods provided by various embodiments of the present disclosure may be implemented.

The memory 601 may be configured to store instructions or applications executable by the processor 602, and may also cache data to be processed or already processed (e.g., image data, audio data, voice communication data, and video communication data) in the processor 602 and various modules in the electronic device 600. The memory may be implemented using flash memory (FLASH) or random access memory (RAM).

The descriptions of the storage medium and device embodiments above are similar to those of the method embodiments above, and have similar beneficial effects. For technical details not disclosed in the storage medium and device embodiments of this application, reference can be made to the descriptions of the method embodiments of this application for understanding.

It should be understood that the phrase “one embodiment” or “an embodiment” throughout the specification means that a specific feature, structure, or characteristic related to an embodiment is included in at least one embodiment of the present disclosure. Therefore, “in one embodiment” or “in an embodiment” appearing throughout the specification does not necessarily refer to the same embodiment. Furthermore, these specific features, structures, or characteristics can be combined in any suitable manner in one or more embodiments. It should be understood that in the various embodiments of this disclosure, the sequence number of the above steps/processes does not imply a sequential order of execution; the execution order of each step/process should be determined by its function and internal logic, and should not constitute any limitation on the implementation process of the embodiments of this disclosure. The sequence numbers of the embodiments disclosed above are for descriptive purposes only and do not represent the superiority or inferiority of the embodiments.

It should be noted that, in this document, the terms “comprising,” “including,” or any other variations thereof are intended to cover non-exclusive inclusion, such that a process, method, article, or apparatus that includes a list of elements includes not only those elements but also other elements not expressly listed, or elements inherent to such a process, method, article, or apparatus. Without further limitations, an element defined by the phrase “including a . . .” does not exclude the presence of other identical elements in the process, method, article, or apparatus that includes that element.

In the embodiments provided by the present disclosure, it should be understood that the disclosed devices and methods can be implemented in other ways. The device embodiments described above are merely illustrative. For example, the division of units is only a logical functional division. In actual implementation, there may be other division methods, such as multiple units or components being combined, integrated into another system, or some features being ignored or not executed. Furthermore, the coupling, direct coupling, or communication connection between the various components shown or discussed can be indirect coupling or communication connection through interfaces, devices, or units, and can be electrical, mechanical, or other forms.

The units described above as separate components may or may not be physically separate. The components shown as units may or may not be physical units. They can be located in one place or distributed across multiple network units. Some or all of the units can be selected to achieve the purpose of the present disclosure according to actual needs.

Further, the functional units in the embodiments of this disclosure can all be integrated into one processing unit, or each unit can be a separate unit, or two or more units can be integrated into one unit. The integrated unit can be implemented in hardware or in a combination of hardware and software functional units.

Those skilled in the art should understand that all or part of the steps in the above method embodiments may be implemented by hardware related to program instructions. The aforementioned program may be stored in a computer-readable storage medium. When executed, the program may perform the steps of the above method embodiments. The aforementioned storage medium may include various media capable of storing program code, such as mobile storage devices, read-only memory (ROM), magnetic disks, or optical disks.

In some embodiments, when the integrated units of this disclosure are implemented as software functional modules and sold or used as independent products, they may also be stored in a computer-readable storage medium. Based on this understanding, the technical solution of this disclosure, can be embodied in the form of a software product. This computer software product may be stored in a storage medium and include several instructions to cause a computer device (which may be a personal computer, server, or network device, etc.) to execute all or part of the methods described in the various embodiments of this disclosure. The aforementioned storage medium may include various media capable of storing program code, such as mobile storage devices, ROMs, magnetic disks, or optical disks.

The methods disclosed in the several method embodiments provided by the present disclosure can be arbitrarily combined to obtain new method embodiments in the absence of conflict.

The features disclosed in the several product embodiments provided by the present disclosure can be arbitrarily combined to obtain new product embodiments in the absence of conflict.

The features disclosed in the several method or device embodiments provided by the present disclosure can be arbitrarily combined to obtain new method embodiments or device embodiments in the absence of conflict.

The embodiments of the present disclosure have been described above. However, these embodiments are merely illustrative and not intended to limit the scope of the present disclosure. Although various embodiments have been described above, this does not mean that the measures in the various embodiments cannot be used advantageously in combination. Various substitutions and modifications can be made by those skilled in the art without departing from the scope of the present disclosure, and all such substitutions and modifications should fall within the scope of the present disclosure.

What is claimed is:

1. An electronic device comprising:
a first body including a first surface and a second surface opposite to each other;
a second body rotatably connected to the first body and including a third surface and a fourth surface opposite to each other; and
a display unit disposed at the first surface and the third surface, the first surface being a first display area of the display unit and the third surface being a second display area of the display unit,
wherein the electronic device is configured to have:
a first attitude, in which the first surface and the third surface are coplanar, an angle between the second surface and the fourth surface is a first angle, the first display area outputs a first portion of an image, and the second display area outputs a second portion of the image, such that the image presents a first target visual effect; and
a second attitude, in which the first surface and the third surface are not coplanar, the angle between the second surface and the fourth surface is a second angle smaller than the first angle, the first display area outputs the first portion of the image, and the second display area outputs the second portion of the image, such that the image presents a second target visual effect different from the first target visual effect.

2. The electronic device according to claim 1, wherein:
the image is a two-dimensional image;
when the electronic device is in the first attitude, the two-dimensional image output by the display unit has a planar visual effect; and
when the electronic device is in the second attitude, the two-dimensional image output by the display unit has a stereoscopic visual effect.

3. The electronic device according to claim 2, wherein:
the electronic device is configured to have:
a first usage state, in which the angle between the second surface and the fourth surface is the first angle; and
a second usage state, in which the angle between the second surface and the fourth surface is a third angle smaller than the second angle; and
during a process of the electronic device switching between the first usage state and the second usage state, one or more fluid-related display parameters in the image are adjusted such that a changing trend of an angle between a flow path of fluid in the first display area and a flow path of fluid in the second display area is opposite to a changing trend of the angle between the first body and the second body.

4. The electronic device according to claim 3, wherein:
the electronic device is in the second usage state when the third angle is within a preset angle range; or
the electronic device further includes a third body connected to the second body and having a fifth surface that is able to face the third surface, the electronic device being in the second usage state when the third angle is less than or equal to an angle between the third surface and the fifth surface.

5. The electronic device according to claim 1, wherein during a process of the electronic device switching between the first attitude and the second attitude, display information of the first portion of the image output by the first display area and display information of the second portion of the image output by the second display area are adjusted such that the image presents different display effects.

6. The electronic device according to claim 5, wherein:
the display information includes a display position of a target image element;
during the process of the electronic device switching between the first attitude and the second attitude, relative position change information between the first body and the second body is obtained; and
based on the relative position change information, the display position of the target image element is adjusted.

7. The electronic device according to claim 5, wherein:
the display unit further includes a third display area connected to the first display area and the second display area, and able to have different display orientations; and
adjusting the display information of the first portion of the image output by the first display area and the display information of the second portion of the image output by the second display area during the switching of the electronic device between the first attitude and the second attitude includes:
in response to the electronic device switching from the first attitude to the second attitude, adjusting the display position of the target image element in the image to move from a position away from the third display area to a position closer to the third display area; or
in response to the electronic device switching from the second attitude to the first attitude, adjusting the display position of the target image element in the image to move from a position closer to the third display area to a position away from the third display area.

8. The electronic device according to claim 5, wherein:
the display unit further includes a third display area connected to the first display area and the second display area, and able to have different display orientations; and
adjusting the display information of the first portion of the image output by the first display area and the display information of the second portion of the image output by the second display area during the switching of the electronic device between the first attitude and the second attitude includes:
in response to the electronic device switching from the first attitude to the second attitude, adjusting the display position of the target image element in the image to move from the first display area, through the third display area, to the second display area, a movement distance of the target image element in the first display area and a movement distance of the target image element in the second display area being same; or
in response to the electronic device switching from the second attitude to the first attitude, adjusting the display position of the target image element in the image to move from the second display area, through the third display area, to the first display area, the movement distance of the target image element in the first display area and the movement distance of the target image element in the second display area being same.

9. The electronic device according to claim 5, wherein:
the display unit further includes a third display area connected to the first display area and the second display area, and able to have different display orientations;
the target image element includes a first sub-element that is able to be displayed in the first display area and a second sub-element that is able to be displayed in the second display area, and the first sub-element and the second sub-element are symmetrical to each other with respect to the third display area; and
adjusting the display information of the first portion of the image output by the first display area and the display information of the second portion of the image output by the second display area during the switching of the electronic device between the first attitude and the second attitude includes:
in response to the electronic device switching from the first attitude to the second attitude, adjusting display positions of the first sub-element and the second sub-element from positions far from the third display area to positions close to the third display area, a movement distance of the first sub-element matching a movement distance of the second sub-element; or
in response to the electronic device switching from the second attitude to the first attitude, adjusting the display positions of the first sub-element and the second sub-element to move from positions close to the third display area to positions far away from the third display area, the movement distance of the first sub-element matching the movement distance of the second sub-element.

10. A display method applied to an electronic device, the electronic device including a first body with a first surface and a second surface opposite to each other, a second body rotatably connected to the first body with a third surface and a fourth surface opposite to each other, and a display unit disposed at the first surface and the third surface with the first surface being a first display area of the display unit and the third surface being a second display area of the display unit, the method comprising:
in response to determining that the electronic device is in a first attitude where the first surface and the third surface are coplanar and an angle between the second surface and the fourth surface is a first angle, setting the first display area to output a first portion of an image, and the second display area to output a second portion of the image, such that the image presents a first target visual effect; and
in response to determining that the electronic device is in a second attitude where the first surface and the third surface are not coplanar and the angle between the second surface and the fourth surface is a second angle smaller than the first angle, setting the first display area too output the first portion of the image, and the second display area to output the second portion of the image, such that the image presents a second target visual effect different from the first target visual effect.

11. The display method according to claim 10, wherein:
the image is a two-dimensional image;
when the electronic device is in the first attitude, the two-dimensional image output by the display unit has a planar visual effect; and
when the electronic device is in the second attitude, the two-dimensional image output by the display unit has a stereoscopic visual effect.

12. The display method according to claim 11,
wherein the electronic device is configured to have:
a first usage state, in which the angle between the second surface and the fourth surface is the first angle; and
a second usage state, in which the angle between the second surface and the fourth surface is a third angle smaller than the second angle;
the method further comprising:
during a process of the electronic device switching between the first usage state and the second usage state, adjusting one or more fluid-related display parameters in the image such that a changing trend of an angle between a flow path of fluid in the first display area and a flow path of fluid in the second display area is opposite to a changing trend of the angle between the first body and the second body.

13. The display method according to claim 12, wherein:
the electronic device is in the second usage state when the third angle is within a preset angle range; or
the electronic device further includes a third body connected to the second body and having a fifth surface that is able to face the third surface, the electronic device being in the second usage state when the third angle is less than or equal to an angle between the third surface and the fifth surface.

14. The display method according to claim 10, further comprising:
during a process of the electronic device switching between the first attitude and the second attitude, adjusting display information of the first portion of the image output by the first display area and display information of the second portion of the image output by the second display area such that the image presents different display effects.

15. The display method according to claim 14, wherein:
the display information includes a display position of a target image element; and
adjusting the display information of the first portion of the image and the display information of the second portion includes:
obtaining relative position change information between the first body and the second body; and
adjusting, based on the relative position change information, the display position of the target image element.

16. The display method according to claim 14, wherein:
the display unit further includes a third display area connected to the first display area and the second display area, and able to have different display orientations; and
adjusting the display information of the first portion of the image output by the first display area and the display information of the second portion of the image output by the second display area during the switching of the electronic device between the first attitude and the second attitude includes:
in response to the electronic device switching from the first attitude to the second attitude, adjusting the display position of the target image element in the image to move from a position away from the third display area to a position closer to the third display area; or
in response to the electronic device switching from the second attitude to the first attitude, adjusting the display position of the target image element in the image to move from a position closer to the third display area to a position away from the third display area.

17. The display method according to claim 14, wherein:
the display unit further includes a third display area connected to the first display area and the second display area, and able to have different display orientations; and
adjusting the display information of the first portion of the image output by the first display area and the display information of the second portion of the image output by the second display area during the switching of the electronic device between the first attitude and the second attitude includes:
in response to the electronic device switching from the first attitude to the second attitude, adjusting the display position of the target image element in the image to move from the first display area, through the third display area, to the second display area, a movement distance of the target image element in the first display area and a movement distance of the target image element in the second display area being same; or
in response to the electronic device switching from the second attitude to the first attitude, adjusting the display position of the target image element in the image to move from the second display area, through the third display area, to the first display area, the movement distance of the target image element in the first display area and the movement distance of the target image element in the second display area being same.

18. The display method according to claim 14, wherein:
the display unit further includes a third display area connected to the first display area and the second display area, and able to have different display orientations;
the target image element includes a first sub-element that is able to be displayed in the first display area and a second sub-element that is able to be displayed in the second display area, and the first sub-element and the second sub-element are symmetrical to each other with respect to the third display area; and
adjusting the display information of the first portion of the image output by the first display area and the display information of the second portion of the image output by the second display area during the switching of the electronic device between the first attitude and the second attitude includes:
in response to the electronic device switching from the first attitude to the second attitude, adjusting display positions of the first sub-element and the second sub-element from positions far from the third display area to positions close to the third display area, a movement distance of the first sub-element matching a movement distance of the second sub-element; or
in response to the electronic device switching from the second attitude to the first attitude, adjusting the display positions of the first sub-element and the second sub-element to move from positions close to the third display area to positions far away from the third display area, the movement distance of the first sub-element matching the movement distance of the second sub-element.

19. A non-transitory computer-readable storage medium storing a computer program that, when executed by a processor of an electronic device, cause the electronic device to perform a display method, wherein:
the electronic device includes a first body with a first surface and a second surface opposite to each other, a second body rotatably connected to the first body with a third surface and a fourth surface opposite to each other, and a display unit disposed at the first surface and the third surface with the first surface being a first display area of the display unit and the third surface being a second display area of the display unit; and
the method includes:
in response to determining that the electronic device is in a first attitude where the first surface and the third surface are coplanar and an angle between the second surface and the fourth surface is a first angle, setting the first display area to output a first portion of an image, and the second display area to output a second portion of the image, such that the image presents a first target visual effect; and
in response to determining that the electronic device is in a second attitude where the first surface and the third surface are not coplanar and the angle between the second surface and the fourth surface is a second angle smaller than the first angle, setting the first display area too output the first portion of the image, and the second display area to output the second portion of the image, such that the image presents a second target visual effect different from the first target visual effect.

20. The storage medium according to claim 19, wherein:
the image is a two-dimensional image;
when the electronic device is in the first attitude, the two-dimensional image output by the display unit has a planar visual effect; and
when the electronic device is in the second attitude, the two-dimensional image output by the display unit has a stereoscopic visual effect.
